(19) United States
(12) Patent Application Publication
(10) Pub. No.: US 2024/0316557 A1
(43) Pub. Date: Sep. 26, 2024

(54) MICROFLUIDIC PLATFORM FOR DIGITAL DROPLET BIOASSAY WITH SPATIALLY PROGRAMMABLE THERMAL CYCLER

(71) Applicants: Versitech Limited, Hong Kong (HK); Advanced Biomedical Instrumentation Centre Limited, Hong Kong (HK)

(72) Inventors: Jingxuan TIAN, Hong Kong (HK); Ho Cheung SHUM, Hong Kong (HK); Aditi DEY POONAM, Hong Kong (HK); Lang NAN, Hong Kong (HK)

(21) Appl. No.: 18/607,538

(22) Filed: Mar. 17, 2024

Related U.S. Application Data
(60) Provisional application No. 63/491,966, filed on Mar. 24, 2023.

(51) Int. Cl. B01L 3/00; B01L 7/00

(52) U.S. Cl. CPC B01L 3/502784; B01L 7/525; B01L 2200/0636; B01L 2200/0673; B01L 2200/147; B01L 2300/0883; B01L 2300/1822

(57) ABSTRACT

A portable, miniaturized microfluidic droplet-based digital polymerase chain reaction (PCR) device is provided. The device includes a droplet generation layer with a flow-focusing channel and multiple capillary channels, in which the flow-focusing channel has a flow focusing structure to generate droplets from a provided aqueous sample and extract oil, and the multiple capillary channels is configured to perform an oil extraction. An incubation layer includes heating plates, a microfluidic channel, and a container for conducting a PCR thermal cycling program. Controlled by a controller and powered by a power supplier, the PCR thermal cycling program involves maintaining predefined temperatures on each heating plate sequentially. This process ensures the heating of droplets to different temperatures at distinct times, facilitating precise and efficient PCR amplification.

### CROSS-REFERENCE TO RELATED APPLICATIONS

The present application claims priority from U.S. provisional patent application Ser. No. 63/491,966 filed Mar. 24, 2023, and the disclosure of which is incorporated herein by reference in its entirety.

### FIELD OF THE INVENTION

The present invention generally relates to the fields of bioassay technology. More specifically the present invention relates to a microfluidic platform with spatially programmable thermal cycler with multiple temperature zones.

### BACKGROUND OF THE INVENTION

Point-of-care testing (POCT), alternatively known as near-patient testing or bedside testing, plays a crucial role in conducting medical diagnostic testing at or near the point of care, coinciding with patient care delivery. Polymerase chain reaction (PCR) stands out as one of the prevalent POCT methods, especially vital during epidemics for real-time monitoring of patient progress and treatment efficacy. However, the increased demand for POCT during epidemics can strain testing facilities, underscoring the imperative for efficient methods to alleviate the workload.

Currently, two primary types of digital PCR machines facilitate absolute target quantification. The first type employs microscale wells for compartmentalized PCR reactions. However, its limited number of compartments compromises the dynamic range it can effectively measure. The second type is droplet-based digital PCR, which necessitates separate machines for droplet generation, thermal cycling, and screening. This sequential workflow demands manual sample transfer between machines, posing a risk of sample loss and potentially diminishing overall efficiency.

In order to solve these challenges, the present invention aims to fulfill the need for a portable, bedside POCT device that offers a wide dynamic range, absolute quantification, minimum manual operation. By addressing these critical aspects, the invention contributes to enhancing the efficiency and accessibility of point-of-care testing, particularly in scenarios of increased demand such as during epidemics.

### SUMMARY OF THE INVENTION

It is an objective of the present invention to provide a device to solve the aforementioned technical problems.

In accordance with a first aspect of the present invention, a portable, miniaturized microfluidic droplet-based digital PCR device is provided. Particularly, the device includes a droplet generation layer with a flow-focusing channel and multiple capillary channels, wherein the flow-focusing channel has a flow focusing structure to generate droplets from a provided aqueous sample and extract oil, and the multiple capillary channels is configured to perform an oil extraction; an incubation layer, including heating plates, a microfluidic channel and a container and configured to conduct a PCR thermal cycling program; a controller; and a power supplier. The PCR thermal cycling program herein denotes that each of the heating plates is set to maintain a predefined temperature, respectively, so as to heating the droplets to different temperatures at different time.

In accordance with one embodiment of the present invention, the outlet of the flow-focusing channel is coincided with the opening of the microfluidic channel, and the outlet of the microfluidic channel is connected to the container.

In accordance with one embodiment of the present invention, the droplets enter and flow through the microfluidic channel to the container.

In accordance with one embodiment of the present invention, the microfluidic channel is positioned on the heating plates, so that the droplets flowed through are heated to the different predefined temperatures throughout the flow.

In accordance with one embodiment of the present invention, the microfluidic channel travels back and forth among the heating plates.

In accordance with one embodiment of the present invention, a duration that the droplets spend on each heating plates is adjustable by regulating the length, geometry and shape of the microfluidic channel on the heating plates.

In accordance with one embodiment of the present invention, the microfluidic channel is designed with serpentine patterns to enhance thermal homogeneity across droplets during PCR thermal cycling.

In accordance with one embodiment of the present invention, the droplets completing the PCR thermal cycling program are stored in the container as a final product.

In accordance with one embodiment of the present invention, the device further includes a fluorescent detecting module to measure a fluorescent intensity of the final product.

In accordance with one embodiment of the present invention, the droplet generation layer and the incubation layer are connected in a stack-wise manner or a dock-wise manner.

In accordance with one embodiment of the present invention, the number of the heating plates is 3, each with the predefined temperature of 50° C., 78° C. and 95° C., respectively.

In accordance with one embodiment of the present invention, heaters are respectively connected to each of the heating plates for temperature maintenance, wherein each of the heaters is attached with a thermistor for temperature monitoring and electrically connected to the controller.

In accordance with one embodiment of the present invention, each heating plate is attached with a thermistor for temperature monitoring; and the controller turns off the heater when the thermistor detects a temperature higher than the predefined temperature and turns on the heater when a lower temperature is detected.

In accordance with one embodiment of the present invention, the droplet generation layer comprises a mechanism for adjusting the oil-to-sample ratio to optimize droplet generation efficiency.

### BRIEF DESCRIPTION OF THE DRAWINGS

Embodiments of the invention are described in more details hereinafter with reference to the drawings, in which:

FIGS. 1A-1B depict a schematic diagram showing the channel design of a microfluidic droplet-based digital PCR device, in which FIG. 1A outlines the overview of the microfluidic droplet-based digital PCR device, and FIG. 1B depicts the multiple capillary channels and the flow focusing channel;

FIG. 2 illustrates the structures and components of a heater for maintain the temperature of heating plates;

FIG. 3 depicts a stack-wise manner for assembling two layers of the device;

FIG. 4 depicts the circuit of the thermal cycler;

FIG. 5 depicts the circuit of the thermistors; and

FIG. 6 shows the circuit of the thermal cycler.

### DETAILED DESCRIPTION

In the following description, apparatuses and devices of microfluidic droplet-based digital polymerase chain reaction and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance with a first aspect of the present invention, a portable, miniaturized microfluidic droplet-based digital polymerase chain reaction (PCR) device is provided. Particularly, the device is integrated with a thermal cycler.

The device includes a droplet generation layer, housing a flow-focusing channel and multiple capillary channels, wherein the flow-focusing channel has a flow focusing structure to generate droplets from a provided aqueous sample and extract oil, and the multiple capillary channels is configured to perform an oil extraction; and an incubation layer equipped with heating plates, a microfluidic channel, and a container, designed to conduct a PCR thermal cycling program. This program involves maintaining each of the heating plates at a predefined temperature, thus subjecting the droplets to different temperatures at different times, facilitating optimal PCR amplification. It is worth noting that the droplet generation layer is equipped with a flow-focusing channel and multiple capillary channels, where the flow-focusing channel has a flow focusing structure to generate droplets from a provided aqueous sample and extract oil, and the multiple capillary channels is configured to perform an oil extraction

The term “droplets generation and/or generate droplets” used herein refer to a droplet generation process realized by flow focusing structure that the channel is in a cross-junction structure, so that the oil shears off the aqueous flow (with sample) at the junction into droplets.

The flow-focusing channel's outlet aligns with the microfluidic channel's opening, ensuring a seamless transition of droplets from generation to subsequent thermal cycling, and the outlet of the microfluidic channel connects to the container where the final PCR products are stored. The microfluidic channel, positioned on the heating plates, facilitates the controlled heating of droplets to varying temperatures as they traverse back and forth among the heating plates for completing multiple cycling circles. The microfluidic channel's geometry, length, and shape are adjustable to regulate the duration that droplets spend on each heating plate, offering flexibility in the PCR program.

To enhance thermal homogeneity, the microfluidic channel is designed with serpentine patterns. Additionally, the device integrates a fluorescent detecting module to measure the fluorescent intensity of the final PCR products, ensuring accurate detection and quantification. The number of heating plates, set at predefined temperatures, can be customized, and the device is equipped with heaters connected to each heating plate for temperature maintenance, with thermistors for continuous temperature monitoring.

Furthermore, the droplet generation layer includes a mechanism for adjusting the oil-to-sample ratio, optimizing droplet generation efficiency and overall performance. The connection between the droplet generation layer and the incubation layer can be in a stack-wise or dock-wise manner, providing versatility in design.

With the incorporation of a controller and a power supply, this device offers a comprehensive solution for portable, precise, and miniaturized microfluidic droplet-based digital PCR.

In one embodiment, the droplet has a diameter range of 40-80 μm.

In one embodiment, the cycling number is 20-30 cycles.

The device has the droplet generation layer and the incubation layer featuring spatially programmable heating zones and well-defined channel paths that enable functionalized thermal cycling. The droplet generation layer has a flow-focusing channel to compartmentalize the liquid sample into numerous droplets, which then flow back and forth among different temperature zones set on the incubation layer led by a microfluidic channel to perform the thermal cycling. A detection component composed at downstream detects the fluorescent signal of each droplet; by measuring the number of positive droplets among all droplets, an absolute quantification of specific target concentration in the sample with statistical analysis is obtained.

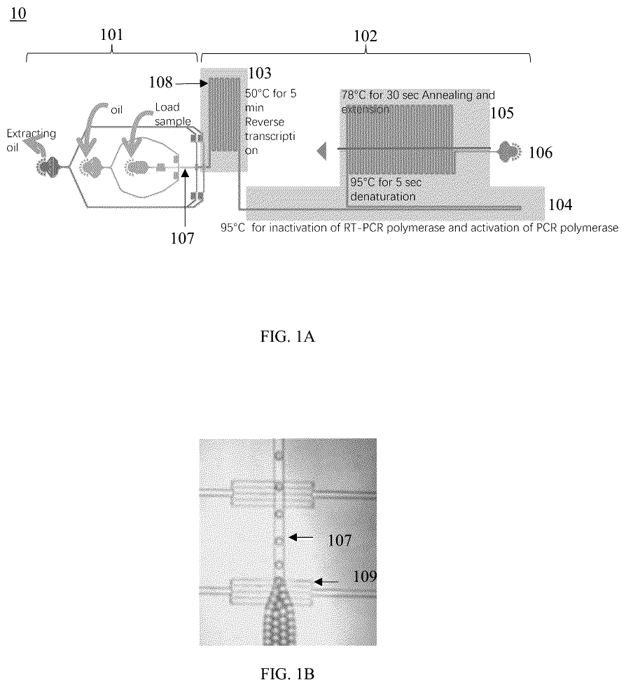

As shown in FIG. 1, the channel design is optimized to generate, incubate, and screen droplets in a highly stable manner. The two layers (101 and 102) of the device 10 are made of PDMS layers with different channel depths. The choice of material of device doesn't limit to PDMS but can be various other materials per need. The end of the droplet generation layer 101 is aligned with the beginning of the incubation layer 102. In the incubation layer 102, due to the combined effect of extracted oil and expanded cross-section, the speed of droplets is significantly decreased; hence, they may stay in corresponding temperature plates (103-105) for prolonged durations.

The device shown in FIG. 1A is designer for a conventional reverse transcription PCR (RT-PCR) process. The droplet generation layer 101 has a flow-focusing channel 107 with a flow focusing structure and multiple capillary channels (detailed in FIG. 1B). A provided aqueous sample flow through the flow-focusing channel 107 to generate droplets from the provided aqueous sample. Subsequently, the formed droplets pass through the multiple capillary channels for oil extraction and enter the incubation layer 102 through the microfluidic channel 108, they encounter the first heating plate 103 set at 50° C. for reverse transcription. Furthermore, the microfluidic channel 108 is in a serpentine pattern so as to adjust the duration of the flow spending on each heating plate. Because of the controllable flow rate and that, the duration on the first heating plate 103 is around 5 minutes for a proper transcription. Next, the sample flows onto the second heating plate 104 with a predefined temperature of 95° C. for inactivation of RT-PCR polymerase and activating PCR polymerases. The third heating plate 105 is set at 78° C. for 30 seconds of annealing and extension. It is worth noting that the second heating plate 104 is next to the third heating plate 105 (may be separated or adherent) and the microfluidic channel 108 meanders back and for between the second (104) and the third (105) heating plates, so as to allow the droplets to be denatured at 95° C. (around 5 seconds) and then go back to the third heating plate 105 for another round of annealing and extension for a repeated cycling treatment. Once it goes through the whole, it enters to the container 106 for fluorescent investigation as final quantitative analysis.

As illustrated in FIG. 1B, the oil extraction is realized by the multiple capillary channels 109 that are overlapped with the flow-focusing channel 107 where droplets are generated and transported from upstream. When the droplets arrive at this area, the multiple capillary channels 109 are at the size that only oil can flow through it so as to extract the oil and block out the droplets. Consequently, the droplets are concentrates and the flow rate is reduced, facilitating the downstream heating cycle.

Particularly, the temperature plates 103-105 can independently change their temperatures per the required thermal cycling process. When droplets containing PCR reagents are generated from a microfluidic device, the droplets will subsequently go through different temperature plates, and this can render the droplet with different temperatures for a specific time. The duration of each temperature can be designed by the length, geometry and shape of the fluid channel through which the droplets flow through. In this way, the droplets undergo the thermal cycling process required for PCR amplification and the target sequence will get amplified if there is any.

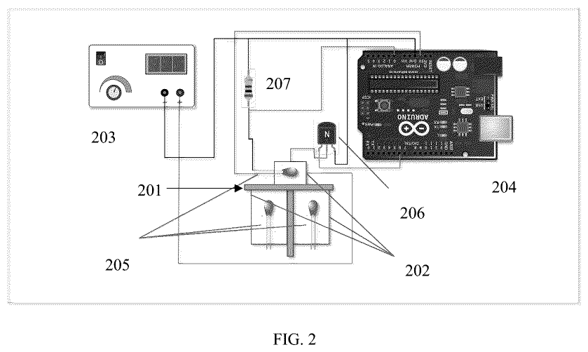

Continuously, the temperature plates are connected to heating components. As shown in FIG. 2, the heating plate 201 is attached with ceramic heater 202. The ceramic heater 202 is powered by a power supplier 203 and controlled by the controller (Arduino) 204. A thermistor 205 is tightly attached to the heating plate 201 to monitor its temperature. Additionally, a resistor 207, placed in the circuit between the controller 204, power supplier 203, and thermistor 205, contributes to the control mechanism as a tunable component. This resistor 207 assists in modulating the electrical characteristics of the circuit, including adjusting the current or voltage to ensure it falls within the operational range of the circuit elements. To initiate thermocycling, the ceramic heater 202 that connects to the power supplier 203 heats the heating plate 201 to a predefined temperature specified in the code. When the thermistor 205 reads a value that is higher than the target temperature, controller 204 will send a signal to the switch 206 and break the loop of the heater 202 to stop heating; likewise, when the temperature is below the target value, the loop will be reconnected to resume heating. The control method may be changed for optimum performance. With precise control over the temperatures of the three heaters, droplets can be guided through them repeatedly to achieve thermal cycling. This heating system works as efficiently as a conventional thermal cycler, but without the need for complicated systems to rapidly increase and decrease the temperature.

It is worth noting that the spatially programmable heating system in the present invention enables various thermal cycling processes with multiple constant temperature zones, avoiding the need for complex systems for fast temperature rise and drop as required by conventional machines. Specifically, the conventional sophisticated thermal cycler is replaced by several fixed-temperature heating plates used as the spatially programmable thermal cycler, allowing the time of thermal cycling to be controlled by the flow rates to adapt to different assays. The wide dynamic concentration range can be measured by quantifying the number of positive droplets, achieving high levels of portability, accuracy, and sensitivity. This alternative technology is highly competitive in resource-limited areas.

Compared to existing conventional ddPCR machines, the present device has the potential to enhance the portability, sensitivity and easy quantification, providing more effective diagnostic information. Further, the device's accuracy enables bed-side self-monitoring tests, facilitating powerful early-stage diagnoses.

The present device is a novel combination of spatially programmable thermal cycler, microfluidic droplet digital assay, and high throughput screening. Utilizing existing microfluidic and bioassay technologies and motivated by the need for practical personalized early-stage diagnosis, the present invention fills a critical gap in current POCT devices.

The droplet-based nature of the digital assay enables absolute quantification of sample concentration and detection of a wider range of target concentration, including ultra-low values. Furthermore, the integration of sample generation and detection into one device minimizes possible sample loss or contamination. The present device integrates the droplet generation, incubation, and detection in a microchip, reducing the machine's size significantly for portable usages.

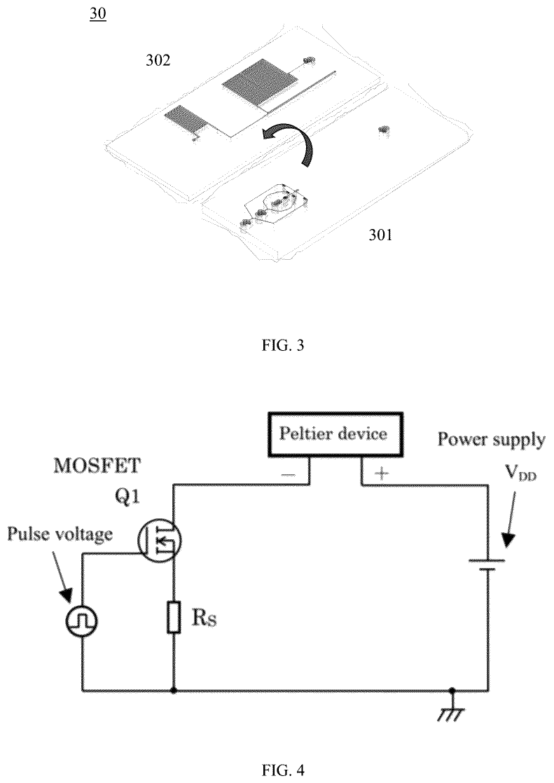

Referring to an alternative embodiment illustrated in FIG. 3, the droplet generation layer 301 and the incubation layer 302 of the device 30 can be directly stacked face-to-face rather than utilizing the junction design. This stacking configuration enhances the device's portability and minimizes space requirements.

In summary, the present device offers a cost-effective and straightforward solution by incorporating fixed temperature heating plates along with customizable droplet paths, making it highly promising for large-scale manufacturing. The independent tunability of temperature zones, coupled with the flexibility to create a grid of temperature zones with higher resolution (such as 3×4, 12×15, etc.), stands out as a notable feature. This thermal cycler's key advantage lies in its use of multiple temperature zones rather than changing temperatures at a single location, resulting in a higher ramping rate. This characteristic enables faster attainment of the required temperature, significantly reducing the overall testing time for each assay.

In one embodiment, the thermal cycler uses IRF450N/IRL450 as a N-channel Mosfet, Peltier module, Aruduino Nano/Uno, and NTC thermistor are used in the device of FIG. 6. The settings are set forth in Table 1.

TABLE 1

| | |
|---|---|
| Typical droplet diameter range | ~40-80 um |
| (May vary per flow rates of | |
| aqueous phase and oil phase, | |
| and the channel geometry) | |
| Temperature zone | 50° C. for reverse transcription; |
| (May vary per different assay | 95° C. for inactivation; |
| kits. Here is an example of | 95° C. (30 s) <-> 78° C.(5 s) for |
| an RT-PCR kit) | denaturation and annealing & |
| | elongation. |
| Temperature range | ±1.52° C. |
| Number of cycling | 20~30 |
| Cycling time | ~30 min |
| Flow speed | ~0.33 mm/s at incubation zone |
| | ~30 mm/s at generation zone |
| Typical channel geometry | Generation zone: 40 um (h), 100 um(w) |
| | Incubation zone: 160 um (h), 250 um(w) |
| | Total channel length: ~500-1000 mm |

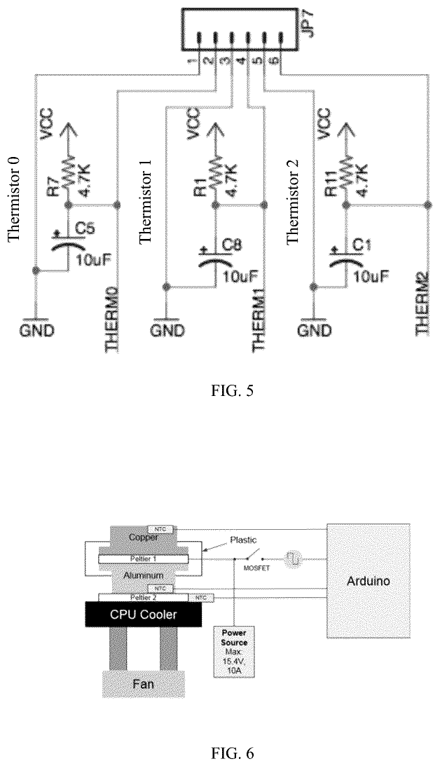

Referring to FIG. 4 and FIG. 5, the circuit of the thermal cycler is depicted. The circuit depicted in FIG. 4 is engineered to regulate the activation and deactivation of a Peltier device. Activation occurs when a pulse voltage, governed by an Arduino in this embodiment, is transmitted to a MOSFET. The MOSFET then functions as a switch, either completing or interrupting the circuit of the Peltier device. Once the microcontroller (as used herein, an programmed Arduino) detects a temperature reading from the thermistor below the set threshold, the microcontroller will issue a command to the MOSFET to initiate heating until the target temperature is achieved.

In another embodiment, as illustrated in FIG. 5, a circuit configuration that connects three thermistors, each tasked with monitoring the temperature within distinct zones. A capacitor is incorporated to smoothen out any noise or fluctuations in the circuit.

Referring to FIG. 6, it illustrates a combination of the temperature control system depicted in FIG. 4 (including an aluminum block, a copper plate, a Peltier device, and a cooling fan) with the temperature measurement setup shown in FIG. 5 (utilizing an NTC thermistor) to achieve the desired functionality. The specifics of the connections may vary, depending on electrical engineering considerations. For instance, in one embodiment, a copper plate strategically positioned atop a Peltier 1. Directly beneath Peltier 1 lies an aluminum plate, forming a layered thermal structure. Remarkably, the aluminum plate sits atop another Peltier module, referred to as Peltier 2 module, which is ingeniously integrated with a CPU cooler featuring an efficient fan for enhanced heat dissipation. Each component, including the copper plate, aluminum plate, and Peltier 2 module, is equipped with a Negative Temperature Coefficient (NTC) device, contributing to the intricately designed temperature control mechanism. The NTC devices play a pivotal role in adjusting the thermal characteristics of the respective components. This entire thermal arrangement is orchestrated by an Arduino microcontroller, interfaced with MOSFETs to precisely modulate the thermal conditions. The Arduino serves as the intelligent brain of the circuit, receiving and interpreting data from various temperature sensors associated with the NTC devices. Based on this data, the Arduino dynamically controls the power supply to the Peltier modules, orchestrating a loop of heating and cooling.

Such a configuration enables the fine-tuning of temperatures across the copper and aluminum plates, as well as the Peltier 2 module. The incorporation of the CPU cooler with a fan further optimizes the overall cooling efficiency of the system. This integrated setup exemplifies a sophisticated thermal regulation mechanism, showcasing the synergy between advanced materials, Peltier modules, and intelligent control facilitated by Arduino and MOSFETs.

Steinhart-Hart equation is used to derive temperature from resistance of NTC thermistors.

$$T = \frac{1}{A + B ln ( R ) + {C [ ln ( R ) ]}^{3}}$$

Source code:

```
  #define R1 24000
  #define nominal_temperature 25
  #define nominal_resistance 100000
  #define beta 3950
  int sensorPin1 = A0;
  int sensorPin2 = A1;
  int sensorPin3 = A2;
  int PWM1 = 3;
  int PWM2 = 5;
  int PWM3 = 6;
  int sensorVal1;
  int sensorVal2;
  int sensorVal3;
  int PWMVal1;
  int PWMVal2;
  int PWMVal3;
  float R2 = 0.0;
  float temperature = 0.0;
  void setup( ) {
  // put your setup code here, to run once:
  pinMode(sensorPin1, INPUT);
  pinMode(sensorPin2, INPUT);
  pinMode(sensorPin3, INPUT);
  pinMode(PWM1, OUTPUT);
  pinMode(PWM2, OUTPUT);
  pinMode(PWM3, OUTPUT);
  Serial.begin(9600);
  }
  void loop( ) {
  // put your main code here, to run repeatedly:
  //this code prints sensor value to the console
  Serial.print(“sen1 = ”);
  Serial.print(sensorVal1);
  Serial.print(“; sen2 = ”);
  Serial.print(sensorVal2);
  Serial.print(“; sen3 = ”);
  Serial.println(sensorVal3);
  delay(1000);
  //read sensor value and set upper limit cap
  sensorVal1 = analogRead(sensorPin1);
  sensorVal2 = analogRead(sensorPin2);
  sensorVal3 = analogRead(sensorPin3);
  R2= R1*(float)sensorVal3 / (1023 − (float)sensorVal3);
  //R2 = 1023 / sensorVal3 − 1;
  //R2= R1 / R2;
  Serial.print(“R2 =”);
  Serial.println(R2);
  temperature = R2 / nominal_resistance;
  temperature = log(temperature);
  temperature /= beta;
  temperature += 1.0 / (nominal_temperature + 273.15); // + (1/To)
  temperature = 1.0 / temperature;
  temperature −= 273.15;
  Serial.print(“temperature = ”);
  Serial.print(temperature);
  Serial.println(“*C”);
  if(temperature >70){
  PWMVal1 = 0;
  }
  if(temperature <70){
  PWMVal1 = 255;
  }
  //1nd high
  if(sensorVal2 >800){
  PWMVal2 = 0;
  }
  if(sensorVal2 <800){
  PWMVal2 = 255;
  //2st high
  /*
  if(temperature >70){
  PWMVal3 = 0 ;
  }
  if(temperature <70){
  PWMVal3 = 255;
  }
  */
  Serial.print(“PWM1 = ”);
  Serial.print(PWMVal1);
  Serial.print(“; PWM2 = ”);
  Serial.print(PWMVal2);
  Serial.print(“; PWM3 = ”);
  Serial.println(PWMVal3);
  //write the PWM value to the pwm output pin
  digitalWrite(PWM1, PWMVal1);
  digitalWrite(PWM2, PWMVal2);
  digitalWrite(PWM3, PWMVal3);
}
```

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A portable, miniaturized microfluidic droplet-based digital polymerase chain reaction (PCR) device, comprising:
a droplet generation layer with a flow-focusing channel and multiple capillary channels, wherein the flow-focusing channel has a flow focusing structure to generate droplets from a provided aqueous sample and extract oil, and the multiple capillary channels is configured to perform an oil extraction;
an incubation layer, comprising heating plates, a microfluidic channel and a container and configured to conduct a PCR thermal cycling program;
a controller; and
a power supplier;
wherein the PCR thermal cycling program maintains each of the heating plates at a predefined temperature, respectively, so as to heat the droplets to different temperatures at different time.

2. The device of claim 1, wherein the outlet of the flow-focusing channel is coincided with the opening of the microfluidic channel, and the outlet of the microfluidic channel is connected to the container.

3. The device of claim 2, wherein the droplets enter and flow through the microfluidic channel to the container.

4. The device of claim 3, wherein the microfluidic channel is positioned on the heating plates, so that the droplets flowed through are heated to the different predefined temperatures throughout the flow.

5. The device of claim 4, wherein the microfluidic channel travels back and forth among the heating plates.

6. The device of claim 4, wherein a duration that the droplets spend on each heating plates is adjustable by regulating the length, geometry and shape of the microfluidic channel on the heating plates.

7. The device of claim 6, wherein the microfluidic channel is designed with serpentine patterns to enhance thermal homogeneity across droplets during PCR thermal cycling.

8. The device of claim 4, wherein the droplets completing the PCR thermal cycling program are stored in the container as a final product.

9. The device of claim 8, wherein the device further comprises a fluorescent detecting module to measure a fluorescent intensity of the final product.

10. The device of claim 1, wherein the droplet generation layer and the incubation layer are connected in a stack-wise manner or a dock-wise manner.

11. The device of claim 4, wherein the number of the heating plates is 3, each with the predefined temperature of 50° C., 78° C. and 95° C., respectively.

12. The device of claim 1, wherein heaters are respectively connected to each of the heating plates for temperature maintenance, wherein each of the heaters is attached with a thermistor for temperature monitoring and electrically connected to the controller.

13. The device of claim 12, wherein each heating plate is attached with a thermistor for temperature monitoring; and the controller turns off the heater when the thermistor detects a temperature higher than the predefined temperature and turns on the heater when a lower temperature is detected.

14. The device of claim 1, wherein the droplet generation layer comprises a mechanism for adjusting the oil-to-sample ratio to optimize droplet generation efficiency.
